(19) United States
(12) Patent Application Publication
(10) Pub. No.: US 2025/0290435 A1
(43) Pub. Date: Sep. 18, 2025

(54) CONTROLLER FOR FORCED-INDUCTION ENGINE

(71) Applicant: TOYOTA JIDOSHA KABUSHIKI KAISHA, Toyota-shi (JP)

(72) Inventor: Keisuke KIMURA, Toyota-shi (JP)

(21) Appl. No.: 19/077,058

(22) Filed: Mar. 12, 2025

(30) Foreign Application Priority Data
Mar. 14, 2024 (JP) 2024-039989

(51) Int. Cl. F01M 13/02; F01M 13/04

(52) U.S. Cl. CPC F01M 13/022; F01M 2013/027; F01M 2013/0477

(57) ABSTRACT

A forced-induction engine includes a first ventilation passage that connects a crankcase to a portion of an intake passage downstream of a compressor and upstream of a throttle valve, a second ventilation passage that connects the crankcase to a portion of the intake passage upstream of the compressor, and a unidirectional valve configured to restrict a flow of gas from the crankcase toward the intake passage through the first ventilation passage. A controller for the forced-induction engine includes processing circuitry configured to determine whether a water accumulation amount in engine oil is relatively large, and when determining that the water accumulation amount is relatively large during operation of the forced-induction engine in a naturally-aspirated region, perform boost operation of the forced-induction engine by increasing a boost efficiency of the compressor and increasing an opening degree of a throttle valve.

### CROSS-REFERENCE TO RELATED APPLICATIONS

This application is based upon and claims the benefit of priority from Japanese Patent Application No. 2024-039989, filed on Mar. 14, 2024, the entire contents of which are incorporated herein by reference.

### BACKGROUND

### 1. Field

The present disclosure relates to a controller for a forced-induction engine.

### 2. Description of Related Art

Japanese Laid-Open Utility Model Publication No. 57-013814 discloses a forced-induction engine capable of ventilating a crankcase. This is achieved by providing a ventilation passage that connects the downstream side of a compressor to the crankcase through a unidirectional valve.

When the conventional forced-induction engine disclosed in the above-described publication is operated in a forced-induction region, intake air pressurized by the compressor is introduced into the crankcase through the ventilation passage. This allows for ventilation of the crankcase. However, since the compressor does not pressurize intake air during operation of the forced-induction engine in a naturally-aspirated region, ventilation of the crankcase cannot be performed. Therefore, when the operation of the forced-induction engine in the naturally-aspirated region with the engine oil cooled, the water generated by the combustion of fuel and leaked into the crankcase continues to remain in the crankcase. As a result, water mixes with the engine oil, causing emulsion.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A controller for a forced-induction engine according to an aspect of the present disclosure includes processing circuitry. The forced-induction engine includes a turbine disposed in an exhaust passage, a compressor disposed in an intake passage, a throttle valve disposed in a portion of the intake passage downstream of the compressor, a first ventilation passage that connects a crankcase to a portion of the intake passage downstream of the compressor and upstream of the throttle valve, a second ventilation passage that connects the crankcase to a portion of the intake passage upstream of the compressor, and a unidirectional valve configured to restrict a flow of gas from the crankcase toward the intake passage through the first ventilation passage. The processing circuitry is configured to determine whether a water accumulation amount in engine oil is relatively large, and when determining that the water accumulation amount is relatively large during operation of the forced-induction engine in a naturally-aspirated region, perform boost operation of the forced-induction engine by increasing a boost efficiency of the compressor and decreasing an opening degree of the throttle valve.

Other features and aspects will be apparent from the following detailed description, the drawings, and the claims.

### BRIEF DESCRIPTION OF THE DRAWINGS

FIG. 1 is a schematic diagram showing the configuration of a controller for a forced-induction engine according to an embodiment.

FIG. 2 is a flowchart of ventilation promotion control executed by the controller shown in FIG. 1.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

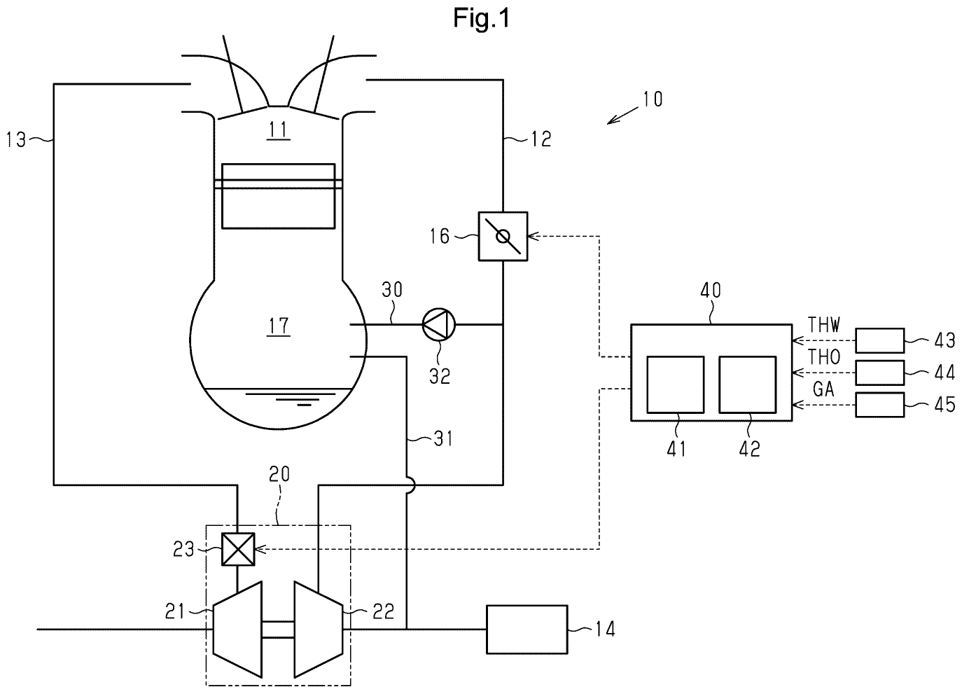

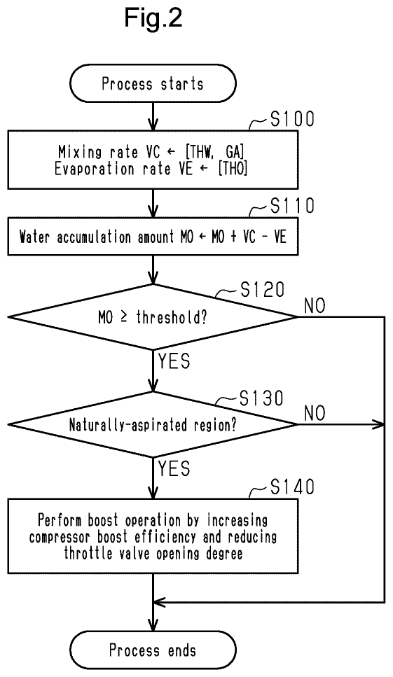

Hereinafter, an embodiment of a controller 40 for a forced-induction engine 10 will be described in detail with reference to FIGS. 1 and 2.

### Configuration of Forced-Induction Engine

First, the configuration of the controller 40 of the forced-induction engine 10 of the present embodiment will be described with reference to FIG. 1. The forced-induction engine 10 controlled by the controller 40 of the present embodiment is a hydrogen engine that generates power by burning hydrogen.

As shown in FIG. 1, the forced-induction engine 10 includes an intake passage 12, through which intake air is drawn into the combustion chamber 11, and an exhaust passage 13, through which exhaust gas is discharged from the combustion chamber 11. The intake passage 12 includes an air cleaner 14, which is a filtering device that purifies intake air, and a throttle valve 16. The throttle valve 16 changes the flow passage area of intake air in the intake passage 12 in proportion to a change in its opening degree.

The forced-induction engine 10 includes a variable displacement turbocharger 20. The turbocharger 20 includes a turbine 21 disposed in the exhaust passage 13, a compressor 22 disposed in the intake passage 12, and a variable nozzle 23. The turbine 21 rotates as the exhaust gas flowing through the exhaust passage 13 strikes the turbine 21. The compressor 22 pressurizes the intake air by rotating in conjunction with the turbine 21. The variable nozzle 23 is capable of changing the opening area of the exhaust blowing port for the turbine 21. The compressor 22 is located in a portion of the intake passage 12 downstream of the air cleaner 14 and upstream of the throttle valve 16.

The forced-induction engine 10 includes two passages, namely, a first ventilation passage 30 and a second ventilation passage 31, each connecting the intake passage 12 to the crankcase 17. The first ventilation passage 30 connects the crankcase 17 to a portion of the intake passage 12 downstream of the compressor 22 and upstream of the throttle valve 16. The second ventilation passage 31 connects the crankcase 17 to a portion of the intake passage 12 downstream of the air cleaner 14 and upstream of the compressor 22. The first ventilation passage 30 includes a unidirectional valve 32 that restricts the flow of gas from the crankcase 17 toward the intake passage 12.

The forced-induction engine 10, which has the above-described configuration, is controlled by a controller 40 including processing circuitry. An example of the controller 40 is an electronic control module for engine control. The controller 40 includes an arithmetic processing device 41 and a storage device 42. The storage device 42 stores a program and data used to control the forced-induction engine 10. The controller 40 executes various processes for controlling the forced-induction engine 10 by the arithmetic processing device 41 executing the program read from the storage device 42. Various sensors that detect the operating state of the forced-induction engine 10 are connected to the controller 40. The sensors include a water temperature sensor 43 and an oil temperature sensor 44, which respectively detect a water temperature THW and an oil temperature THO of the forced-induction engine 10. The sensors also include an air flow meter 45, which detects an intake air amount GA. Based on the detection results of these sensors, the controller 40 determines the operation amount of the forced-induction engine 10. The operation amount of the forced-induction engine 10 determined by the controller 40 includes the opening degree of the throttle valve 16 and the opening degree of the variable nozzle 23 of the turbocharger 20. The controller 40 controls the operating state of the forced-induction engine 10 by operating the actuator and the like of the forced-induction engine 10 according to the determined operation amount.

The controller 40 may be 1) processing circuitry including one or more processors that operate according to a computer program (software); 2) processing circuitry including one or more dedicated hardware circuits such as application specific integrated circuits (ASIC) that execute at least part of various processes, or 3) processing circuitry including a combination thereof. The processor includes a CPU and a memory such as a RAM and a ROM. The memory stores program codes or commands configured to cause the CPU to execute processes. The memory, or a computer-readable medium, includes any type of media that are accessible by general-purpose computers and dedicated computers.

### Ventilation Promotion Control

The ventilation promotion control executed by the controller 40 will now be described with reference to FIG. 2. FIG. 2 illustrates a flowchart of processes executed by the controller 40 for the ventilation promotion control. The controller 40 repeatedly executes the processes of FIG. 2 for a predetermined control cycle while the forced-induction engine 10 is running.

First, upon starting the processes of FIG. 2, the controller 40 calculates a mixing rate VC and an evaporation rate VE in step S100. The mixing rate VC represents the amount of water that mixes into the engine oil per unit time in the crankcase 17. The evaporation rate VE represents the amount of water that evaporates from the engine oil per unit time in the crankcase 17. The controller 40 calculates the mixing rate VC based on the water temperature THW and the intake air amount GA of the forced-induction engine 10, and calculates the evaporation rate VE based on the oil temperature THO.

Subsequently, in step S110, the controller 40 calculates a water accumulation amount MO based on the mixing rate VC and the evaporation rate VE. The water accumulation amount MO represents the amount of water mixed in the engine oil. The controller 40 calculates the water accumulation amount MO by integrating the difference between the mixing rate VC and the evaporation rate VE. Specifically, when calculating the water accumulation amount MO, the controller 40 first subtracts the evaporation rate VE from the mixing rate VC. Then, the controller 40 adds the calculated difference to a pre-update value of the water accumulation amount MO to obtain a post-update value of the water accumulation amount MO. By updating the value of the water accumulation amount MO in this manner, the controller 40 calculates the water accumulation amount MO.

Next, in step S120, the controller 40 determines whether the water accumulation amount MO is greater than or equal to a predetermined threshold. The threshold is set to an upper limit value of the water accumulation amount MO, which allows the generation of emulsion to be limited within an allowable range. When determining that the water accumulation amount MO is greater than or equal to the threshold (YES), the controller 40 advances the process to step S130. When determining that the water accumulation amount MO is less than the threshold (NO), the controller 40 terminates the process of FIG. 2 in the current control cycle.

When advancing the process to step S130, the controller 40 determines whether the current operation region of the forced-induction engine 10 is a naturally-aspirated region in step S130. In the naturally-aspirated region, the operation of the forced-induction engine 10 is performed by natural aspiration when normal control is performed. The determination for the operation region is performed based on, for example, the rotational speed and the load factor of the forced-induction engine 10. When determining that the current operation region of the forced-induction engine 10 is the naturally-aspirated region (YES), the controller 40 advances the process to step S140. When determining that the current operation region of the forced-induction engine 10 is not the naturally-aspirated region (NO), the controller 40 terminates the process of FIG. 2 in the current control cycle.

When advancing the process to step S140, the controller 40 causes the forced-induction engine 10 to perform boost operation by increasing the boost efficiency of the compressor 22 and reducing the opening degree of the throttle valve 16 in step S140. In this step, the controller 40 increases the boost efficiency of the compressor 22 by reducing the opening degree of the variable nozzle 23 to intensify the blowing of exhaust gas to the turbine 21. If only the boost efficiency of the compressor 22 is just increased, the intake air filling rate of the combustion chamber 11 will rise. Therefore, the controller 40 increases the boost efficiency of the compressor 22 while maintaining the intake air filling rate of the combustion chamber 11, by reducing the opening degree of the throttle valve 16. After executing the process of step S140, the controller 40 terminates the process of FIG. 2 in the current control cycle.

### Operation and Advantages of Present Embodiment

The operation and advantages of the present embodiment will now be described.

During a boost operation of the forced-induction engine 10 of FIG. 1, the intake air

pressurized by the compressor 22 is introduced into the crankcase 17 through the first ventilation passage 30. Then, due to the high-pressure intake air introduced into the crankcase 17, the blow-by gas in the crankcase 17 flows out to the portion of the intake passage 12 upstream of the compressor 22 through the second ventilation passage 31. As described above, in the forced-induction engine 10, the crankcase 17 is ventilated during the boost operation. During the naturally-aspirated operation of the forced-induction engine 10, the pressure on the downstream side of the compressor 22 does not become higher than the atmospheric pressure. As a result, the crankcase 17 cannot be ventilated.

In the forced-induction engine 10, some of water generated by the combustion of fuel in the combustion chamber 11 leaks to the crankcase 17. Then, the water may mix into the engine oil in the crankcase 17 to generate emulsion. The forced-induction engine 10 of the present embodiment is a hydrogen engine using hydrogen, which becomes water after combustion, as fuel. Thus, a large amount of water is generated by combustion as compared with a gasoline engine or the like.

The larger the intake air amount GA, the more the amount of fuel burned in the combustion chamber 11 increases. Thus, the amount of water produced by combustion of the fuel also increases. Further, the amount of water leaking from the combustion chamber 11 to the crankcase 17 also increases. Therefore, the mixing rate VC of the water into the engine oil increases as the intake air amount GA increases. When the water temperature THW of the forced-induction engine 10 decreases, the water that has flowed into the crankcase 17 as water vapor is likely to be condensed and mixed into the engine oil. Accordingly, the mixing rate VC of water into the engine oil increases as the water temperature THW decreases. Thus, the mixing rate VC can be calculated as a value that increases as the water temperature THW decreases and increases as the intake air amount GA increases, based on the water temperature THW and the intake air amount GA.

When the oil temperature THO increases, the water mixed in the engine oil evaporates. The amount of water evaporated from the engine oil increases as the oil temperature THO increases. Therefore, the evaporation rate VE of water from the engine oil can be calculated as a value that increases as the oil temperature THO increases, based on the oil temperature THO.

In a unit time, the amount of water mixed in the engine oil increases by the value of the mixing rate VC and decreases by the value of the evaporation rate VE. Thus, the water accumulation amount MO of the engine oil can be calculated as a value obtained by integrating the difference between the mixing rate VC and the evaporation rate VE. The controller 40 of the present embodiment calculates the water accumulation amount MO of the engine oil in this manner. The mixing rate VC used for the calculation of the water accumulation amount MO is calculated based on the water temperature THW and the intake air amount GA, and the evaporation rate VE is calculated based on the oil temperature THO. In this manner, the controller 40 calculates the water accumulation amount MO of the engine oil based on the water temperature THW, the oil temperature THO, and the intake air amount GA of the forced-induction engine 10.

When the engine oil mixed with water is stirred, emulsion is generated. Emulsion is more likely to occur as the water accumulation amount MO of the engine oil increases. In the present embodiment, the threshold is set to the upper limit value of the water accumulation amount MO, which allows the generation amount to be limited to an allowable range. When the water accumulation amount MO further increases beyond the threshold, the amount of emulsion exceeding an allowable upper limit may be generated.

As described above, in the forced-induction engine 10, the crankcase 17 is ventilated during the boost operation. Therefore, even when the water accumulation amount MO exceeds the threshold, if the boost operation is performed in the forced-induction engine 10 in this state, the water in the crankcase 17 is discharged to the intake passage 12 together with the blow-by gas. This limits the generation of emulsion. However, when the naturally-aspirated operation of the forced-induction engine 10 is performed with the water accumulation amount MO greater than the threshold, the water in the crankcase 17 cannot be discharged. As a result, the increase in the water accumulation amount MO cannot be stopped, and thus emulsion occurs.

The controller 40 of the present embodiment increases the boost efficiency of the compressor 22 and reduces the opening degree of the throttle valve 16 when the water accumulation amount MO is greater than or equal to the threshold and the operation region of the forced-induction engine 10 is in the naturally-aspirated region. This causes the forced-induction engine 10 to perform the boost operation in the naturally-aspirated region, in which the naturally-aspirated operation is originally performed. Thus, the ventilation of the crankcase 17 is performed and water in the crankcase 17 is discharged. Consequently, the occurrence of emulsion is limited.

The controller 40 for the forced-induction engine 10 of the above-described present embodiment provides the following advantages.
(1) While the forced-induction engine 10 is running, the controller 40 determines whether the water accumulation amount MO in the engine oil is relatively large. When determining that the water accumulation amount MO is relatively large while the forced-induction engine 10 is running in the naturally-aspirated region, the controller 40 increases the boost efficiency of the compressor 22 and decreases the opening degree of the throttle valve 16. As a result, the controller 40 causes the forced-induction engine 10 operating in the naturally-aspirated region to perform the boost operation so as to ventilate the crankcase 17. When ventilation of the crankcase 17 is performed, further mixing of water into the engine oil is limited. Thus, the controller 40 of the present embodiment limits the occurrence of emulsion.
(2) In the present embodiment, the controller 40 calculates the water accumulation amount MO of the engine oil based on the water temperature THW, the oil temperature THO, and the intake air amount GA of the forced-induction engine 10. As the water temperature THW of the forced-induction engine 10 decreases, the water in the crankcase 17 is more likely to be condensed and mixed into the engine oil. In addition, as the oil temperature THO increases, water in the engine oil is more likely to evaporate. Further, as the intake air amount GA increases, the amount of water generated by combustion and leaking to the crankcase 17 increases. This allows the water accumulation amount MO in the engine oil to be accurately calculated based on the water temperature THW, the oil temperature THO, and the intake air amount GA. The controller 40 determines whether the water accumulation amount MO in the engine oil is relatively large based on whether the water accumulation amount MO is greater than or equal to a predetermined threshold. This allows the controller 40 to accurately determine whether the water accumulation amount MO in the engine oil is relatively large.
(3) The controller 40 of the present embodiment calculates the mixing rate VC of water into the engine oil based on the water temperature THW and the intake air amount GA, and calculates the evaporation rate VE of water from the engine oil based on the oil temperature THO. The controller 40 calculates the water accumulation amount MO by integrating the difference between the mixing rate VC and the evaporation rate VE. This allows the controller 40 to readily and accurately calculate the water accumulation amount MO based on the water temperature THW, the oil temperature THO, and the intake air amount GA.
(4) The controller 40 of the present embodiment is employed in a hydrogen engine, in which a large amount of water is generated by combustion and thus emulsion is likely to occur. This further limits the generation of emulsion caused by the application of the controller 40 of the present embodiment.

### Modifications

The above-described embodiment may be modified as follows. The above-described embodiment and the following modifications can be combined as long as the combined modifications remain technically consistent with each other.

### Calculation of Water Accumulation Amount MO

The controller 40 may calculate the water accumulation amount MO without obtaining the mixing rate VC and the evaporation rate VE. For example, the controller 40 obtains the amount of change in the water accumulation amount MO per unit time based on the water temperature THW, the oil temperature THO, and the intake air amount GA. The controller 40 may calculate the water accumulation amount MO by integrating the amount of change.

The controller 40 may calculate the water accumulation amount MO without using one or more of the water temperature THW, the oil temperature THO, and the intake air amount GA. The controller 40 may use parameters other than the water temperature THW, the oil temperature THO, and the intake air amount GA for the calculation of the water accumulation amount MO.

### Others

The controller 40 may determine whether the water accumulation amount in the engine oil is relatively large without calculating the value of the water accumulation amount MO. For example, the controller 40 may execute the determination as follows. The operating conditions of the forced-induction engine 10 include an operating condition in which the water accumulation amount in the engine oil is likely to increase. The controller 40 measures the time during which the forced-induction engine 10 is operated under the operation condition, in which the water accumulation amount is likely to increase, and determines that the water accumulation amount is relatively large when the time exceeds a certain time.

In the above-described embodiment, the turbocharger 20 of a variable nozzle type is employed in the forced-induction engine 10. As long as the turbocharger can adjust the boost efficiency of the compressor 22, a turbocharger of another type may be employed. For example, a bypass passage through which the exhaust gas flows while bypassing the turbine 21 and a turbocharger including a wastegate valve capable of changing the flow passage area of the exhaust gas in the bypass passage may be employed. In this case, the boost efficiency of the compressor 22 can be increased by reducing the opening degree of the wastegate valve and increasing the flow rate of the exhaust gas blown to the turbine 21.

The controller 40 of the above-described embodiment and the modifications thereof may also be employed in a forced-induction engine other than the hydrogen engine.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

1. A controller for a forced-induction engine, wherein
the forced-induction engine includes:
a turbine disposed in an exhaust passage;
a compressor disposed in an intake passage;
a throttle valve disposed in a portion of the intake passage downstream of the compressor;
a first ventilation passage that connects a crankcase to a portion of the intake passage downstream of the compressor and upstream of the throttle valve;
a second ventilation passage that connects the crankcase to a portion of the intake passage upstream of the compressor; and
a unidirectional valve configured to restrict a flow of gas from the crankcase toward the intake passage through the first ventilation passage, and
the controller comprises processing circuitry configured to:
determine whether a water accumulation amount in engine oil is relatively large; and
when determining that the water accumulation amount is relatively large during operation of the forced-induction engine in a naturally-aspirated region, perform boost operation of the forced-induction engine by increasing a boost efficiency of the compressor and decreasing an opening degree of the throttle valve.

2. The controller for the forced-induction engine according to claim 1, wherein the processing circuitry is configured to:
calculate the water accumulation amount based on a water temperature, an oil temperature, and an intake air amount of the forced-induction engine; and
when a value of the calculated water accumulation amount is greater than or equal to a predetermined threshold, determine that the water accumulation amount is relatively large.

3. The controller for the forced-induction engine according to claim 2, wherein the processing circuitry is further configured to:
calculate a mixing rate of water into the engine oil based on the water temperature and the intake air amount of the forced-induction engine;
calculate an evaporation rate of water from the engine oil based on the oil temperature of the forced-induction engine; and
calculate the water accumulation amount by integrating a difference between the mixing rate and the evaporation rate.

4. The controller for the forced-induction engine according to claim 1, wherein the forced-induction engine is a hydrogen engine.
